(19) United States
(12) Patent Application Publication
(10) Pub. No.: US 2003/0222877 A1
(43) Pub. Date: Dec. 4, 2003

(54) Processor system with coprocessor

(75) Inventors: Kazuhiko Tanaka, Fujisawa (JP); Koji Hosogi, Yokohama (JP); Sigeki Higashijima, Machida (JP); Kiyokazu Nishioka, Odawara (JP)

Correspondence Address: Hogan & Hartson, Biltmore Tower, Suite 1900, 500 South Grand Avenue, Los Angeles, CA, 90071, US

(73) Assignee: HITACHI, LTD.

(21) Appl. No.: 10/439,512

(22) Filed: May 16, 2003

(30) Foreign Application Priority Data
Jun. 3, 2002 (JP) 2002-160902

(51) Int. Cl. G06F 15/16

(52) U.S. Cl. 345/503

(57) ABSTRACT

A processor has a data cache that is connected to a coprocessor via a bus, in which the coprocessor writes results of operations performed within the coprocessor in the data cache inside the processor. The data cache is equipped with a function to write data in a tag memory or a data memory according to a write request from the bus, and the coprocessor is equipped with an address generation device that is capable of designating an address of the data cache as a write address.

### BACKGROUND OF THE INVENTION

1. Field of the Invention

The present invention relates to a processor system with coprocessor in which a coprocessor is mounted on a processor system.

2. Related Background Art

In recent years, there have been increasing demands for moving picture processing using software that utilizes a multimedia processor. The reason for this is that by having software process moving pictures, immediate compatibility with new standards and reduction of LSI development expenses can be achieved. However, due to the fact that moving pictures involve extremely large amount of data compared to still pictures and audio, an enormous amount of operations is involved in their processing.

When using software to process moving pictures, in addition to a technology that uses a single processor for all processing, there is another method that uses a processor specialized to do a specific processing (hereinafter called a “coprocessor”) to perform a processing that requires high operational performance despite the relative simplicity of the processing, such as motion compensation, and uses a main processor to perform the remainder of the processing.

In general, the method that uses a single processor makes it possible to minimize the chip area. However, it requires operating the processor at high operating frequency in order to obtain high operational performance, which can lead to problems in terms of design man-hours and/or power consumption.

On the other hand, the method that uses the coprocessor involves increased chip area but, since operation load is dispersed, allows moving picture processing to be achieved using low operating frequency; this becomes an advantage in fields in which high performance or low power consumption is sought.

For example, in the method for using the coprocessor, for sending and receiving data between a processor and a coprocessor, operation results of the coprocessor are temporarily stored in a memory that is accessible by both the processor and the coprocessor, and the processor reads the operation results.

According to the method described above, by integrating the processor, the coprocessor and the memory on one LSI, the communication among them can take place at high speed. However, this makes the chip area larger and raises the manufacturing cost of the system.

On the other hand, by using a memory external to the chip to send and receive data, a significant increase in the chip area can be avoided. However, since access to an external memory is slower than operations that take place within the LSI, the processing performance of the system as a whole is not improved.

Among technologies to achieve improved performance while limiting an increase in the chip area, there is a technology to mount a memory that is accessible through normal addressing, instead of a cache memory connected to a processor, and to use the memory for communication between the processor and the coprocessor. However, due to the fact that this method involves accessing the memory through normal addressing instead of using a cache memory, the burden on program developers increases, which in turn increases the software development man-hours.

### SUMMARY OF THE INVENTION

The present invention relates to a processor having a data cache that is connected to a coprocessor via a bus, in which the coprocessor writes results of operations performed by the coprocessor in the data cache inside the processor. Instead of writing only data to be transferred to a data memory of the data cache, the coprocessor may also write in a tag memory appropriate fields within an address of the data to be transferred.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a block diagram of a system in accordance with an embodiment of the present invention.

FIGS. 2(a)-2(c) are diagrams for illustrating motion compensation.

FIGS. 3(a)-3(c) are diagrams for illustrating motion compensation.

FIG. 4 is a block diagram of a data transfer engine with motion compensation function.

FIG. 5 is a block diagram of a data cache and its peripheral circuits.

FIG. 6 is a diagram of an example of a pipelined moving picture decompression processing.

FIG. 7 is a diagram of the configuration of another system in accordance with another embodiment of the present invention.

FIG. 8 is a diagram of the configuration of yet another system using the present invention.

FIG. 9 is a diagram of the configuration of a data transfer engine with scaling function.

FIG. 10 is a diagram indicating changes in signals in an internal bus.

### DESCRIPTION OF THE PREFERRED EMBODIMENTS

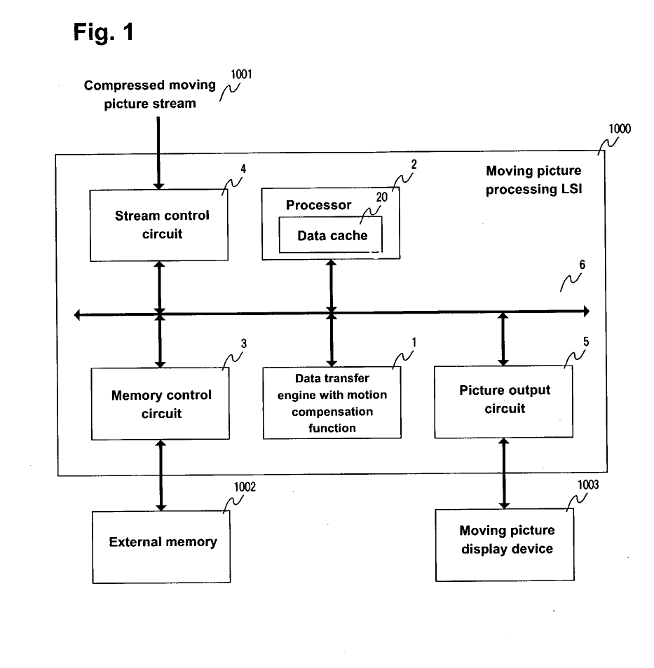

FIG. 1 is a diagram of the configuration of a moving picture processing LSI 1000, which is a system in accordance with an embodiment of the present invention. The moving picture processing LSI 1000 is used to decompress compressed moving pictures and display the pictures. The moving picture processing LSI 1000 is provided with a data transfer engine with motion compensation function 1, a processor 2, a memory control circuit 3, a stream control circuit 4, and a picture output circuit 5, which are mutually connected via an internal bus 6.

The processor 2 has a data cache 20, which is a first memory. The processor 2 may also be provided with an instruction cache in some cases, but this is not shown in FIG. 1. When the processor 2 is considered the main processor of the system, the data transfer engine with motion compensation function 1 becomes a coprocessor. The memory control circuit 3 is a circuit that allows the moving picture processing LSI 1000 to communicate with an external memory 1002, which is a second memory. The instruction system executed by the processor 2 and the data transfer engine with motion compensation function 1 may be the same or different.

The external memory 1002 is not limited to a semiconductor memory and may be any medium that can store data, such as a storage medium that uses magnetism, e.g., a hard disk. The external memory 1002 may be at a remote location via a network. Further, in the future when the degree of integration of LSI has improved, the external memory 1002 may be mounted on the same LSI or become a part of a multi-chip module.

The stream control circuit 4 is a control circuit that transfers to the processor 2 a compressed moving picture stream 1001 that is inputted. The memory control circuit 3 and the stream control circuit 4 may be combined. The picture output circuit 5 is a control circuit to display decompressed pictures on a moving picture display device 1003. The moving picture display device 1003 may be at a remote location via a network.

Although the data transfer engine with motion compensation function 1, the processor 2, the memory control circuit 3, the stream control circuit 4, and the picture output circuit 5 are all integrated on the moving picture processing LSI 1000 according to the present embodiment, which function to integrate on an LSI is arbitrary. In another example, the data transfer engine with motion compensation function 1, the processor 2, the memory control circuit 3, the stream control circuit 4, and the picture output circuit 5 may each be on a separate LSI and connected via a bus among the different chips, or conversely, the external memory 1002 may be on the same chip as the moving picture processing LSI 1000.

The data transfer engine with motion compensation function 1 is a circuit that, while transferring data, renders operations required for motion compensation on the data being transferred. Motion compensation is a technique for obtaining high compression rate by taking advantage of the fact that data of consecutive frames in general moving pictures are extremely similar, and is used in MPEG (Motion Picture Experts Group).

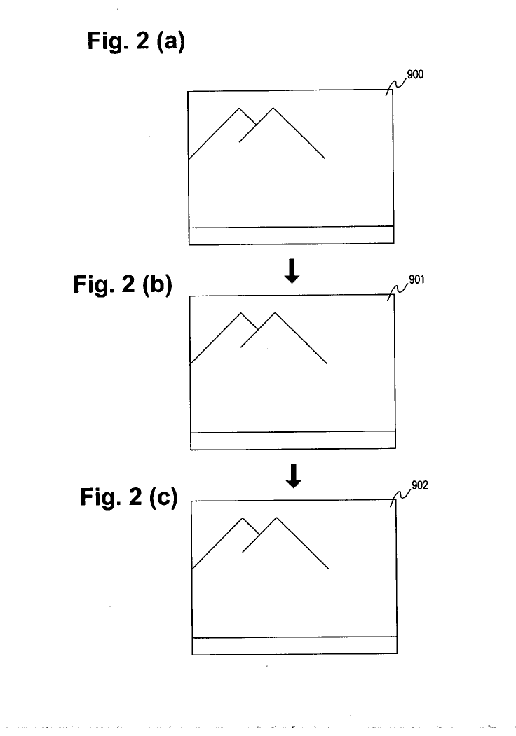

Next, the motion compensation will be briefly described. In moving pictures with only scenery as in FIGS. 2(a)-2(c), since the contents of frames hardly change from one frame to another, data amount can be minimized by repeatedly displaying a certain frame. In reality, since even sceneries do not remain completely still, the difference between frames is determined and compressed further using a different method, and compressed picture data is created.

For example, when compressing a frame n+1, the compression rate can be significantly increased by determining a difference between the frame n+1 and a frame n and compressing the difference data. In this case, the frame n+1 is called a frame to be compressed, and the frame n is called a reference frame.

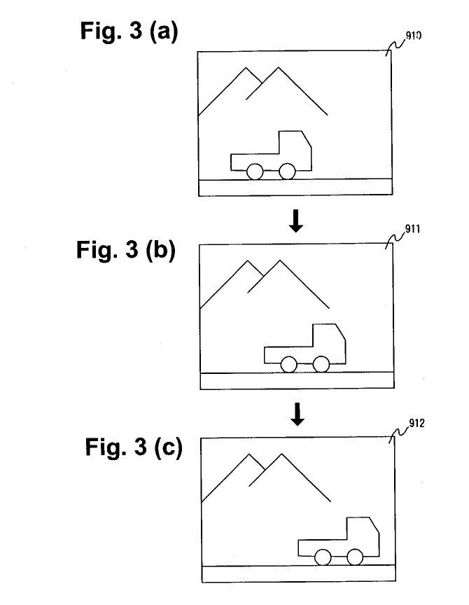

However, for pictures that display moving objects, such as in FIGS. 3(a)-3(c), the effect derived from the compression rate is reduced with the method described above. Accordingly, in this case, each frame is divided into smaller regions (hereinafter called “macro blocks”), and each macro block is compressed. When doing this, the data reduction effect can be maintained by finding from a reference frame a macro block that is most similar to a macro block that is to be compressed and determining the difference between the two. This is the motion compensation technology.

When using the present technology, information that indicates which macro block of the reference frame was used during compression must be retained along with the difference data. This information is generally expressed in terms of the coordinates of the reference macro block relative to the coordinates of the macro block to be compressed, and is called a motion vector. The motion vector is one of the information required to decompress compressed moving pictures.

Normally, the smallest unit involved in the processing of pictures is a pixel, but actual moving pictures do not move on a pixel-by-pixel basis. For this reason, the compression rate can be further improved by designating the set value of the motion vector in even finer units than pixels. In MPEG, values of the motion vector can be set in units of half-pixels using a technique called half-pell.

When using half-pell, a reference macro block can be created by rendering a interpolation processing through arithmetic averaging of two or four adjacent pixels of a reference frame. In addition, MPEG-uses a technology called bidirectional prediction that performs motion compensation by using a plurality of reference frames. These are described in detail in the MPEG Standards and other documents such as The Latest MPEG Textbook edited by Hiroshi Fujiwara and published by ASCII Publications.

The data transfer engine with motion compensation function 1 can control data transfer among devices that are connected to the internal bus 6. In this case, the devices connected to the internal bus 6 include the data cache 20. For example, the data transfer engine with motion compensation function 1 can control a processing that involves reading data from the external memory 1002 via the memory control circuit 3 and writing the data in the data cache 20. In this processing, the data transfer engine with motion compensation function 1 can render an operation processing on the data.

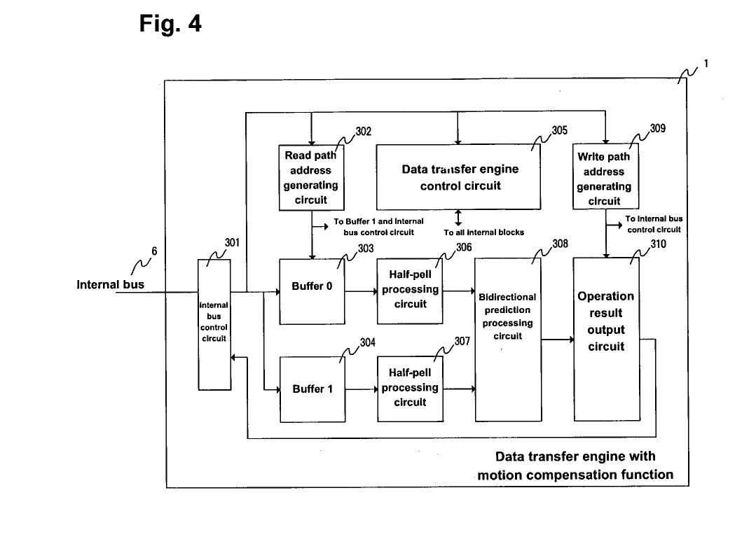

FIG. 4 is a diagram of the internal configuration of the data transfer engine with motion compensation function 1. The data transfer engine with motion compensation function 1 is provided with an internal bus control circuit 301, a read path address generating circuit 302, a buffer 303, a buffer 304, a data transfer engine control circuit 305, half-pell processing circuits 306 and 307, a bidirectional prediction processing circuit 308, a write path address generating circuit 309, and an operation result output circuit 310.

The internal bus control circuit 301 controls sending and receiving of data between the data transfer engine with motion compensation function 1 and the internal bus 6. The read path address generating circuit 302 generates an address when the data transfer engine with motion compensation function 1 performs a read access to the external memory 1002 via the internal bus 6. The read path address generating circuit 302 also generates addresses for the buffer 303 and the buffer 304.

The buffers 303 and 304 are used to store data that are read via the internal bus 6. Although there are two buffer memories in the present embodiment, their number is not limited to two and can be one or three or more.

In the present embodiment, two buffers 303 and 304 are provided to perform simple bidirectional motion compensation. In other words, a macro block of one frame used in a bidirectional prediction is stored in a buffer 0, while a macro block of another frame is stored in a buffer 1. The capacity of each buffer is determined based on a trade-off between processing performance and chip area. In the present embodiment, the capacity for each of the buffers 303 and 304 is designed to be large enough to store a block that is one pixel larger vertically and horizontally than a macro block.

If the size of a macro block is 16 pixels vertically and 16 pixels horizontally, and the number of bits per pixel is 8 bits, the memory capacity required is (16+1)×(16+1)×8 bits. In general, picture data is expressed in terms of a plurality of components, such as RGB, but we will concentrate on the processing of one component for the purpose of description. Even when there are more components, they can be easily handled by mounting a plurality of necessary circuits.

The half-pell processing circuits 306 and 307 are circuits that perform interpolation between pixels when the value of a motion vector is not an integer and is a multiple of a half-pixel. For example, the value of a pixel whose x-coordinate is n+0.5 (where n is an integer) can be found by adding the value of an adjacent pixel whose x-coordinate is n and the value of another adjacent pixel on the other side whose x-coordinate is n+1, and dividing the sum by 2. In the present embodiment, the size of an output picture of the half-pell processing circuits 306 and 307 is 16×16 pixels, which is the same as the size of a macro block.

Outputs from the half-pell processing circuits 306 and 307 are inputted in the bidirectional prediction processing circuit 308. The bidirectional prediction processing circuit 308 processes bidirectional predictions of MPEG. The bidirectional prediction processing circuit 308 calculates an average value for each pixel of two macro blocks inputted and generates a final reference macro block.

The reference macro block generated is outputted to the internal bus 6 via the operation result output circuit 310 and the internal bus control circuit 301. The output destination address is generated by the write path address generating circuit 309. Any device that is connected to the internal bus 6 can be designated the output destination device.

The data transfer engine control circuit 305 is a circuit that controls each block within the data transfer engine with motion compensation function 1, and generates read/write timing signals for the buffers 303 and 304.

Operational units such as the half-pell processing circuits 306 and 307, as well as other components, described are examples, and other types of operational units can be used and/or the number of each operational unit can be varied.

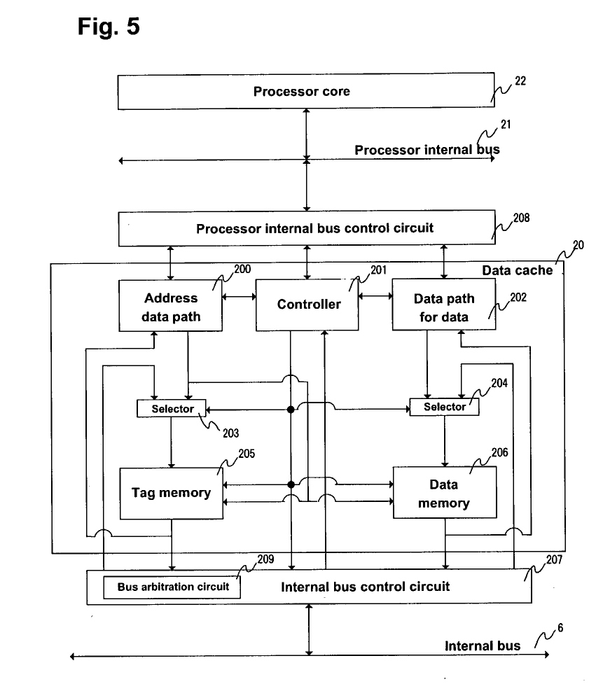

FIG. 5 schematically shows a block diagram of the internal configuration of the data cache 20 and its peripheral circuits. The data cache 20 is connected to both a processor internal bus 21, which is inside the processor 2, and the internal bus 6.

The data cache 20 includes a data path for address 200, a controller 201, a data path for data 202, selectors 203 and 204, a tag memory 205, and a data memory 206. Further, the data cache 20 can access the internal bus 6 via an internal bus control circuit 207, and the processor internal bus 21 via a processor internal bus control circuit 208.

The controller 201 controls each block of the data cache 20. The tag memory 205 stores the tag address and significant bit of each corresponding entry in the data memory 206. The data memory 206 stores data. The selector 203 selects inputs into the tag memory 205. The selector 204 selects inputs into the data memory 206. The internal bus control circuit 207 controls sending and receiving of data between the data cache 20 and the internal bus 6. The internal bus control circuit 208 controls the sending and receiving of data between the data cache 20 and the processor internal bus 21.

When a data write request is made from an internal operational unit of the processor 2 to the data cache 20 via the processor internal bus 21, a part of the write address is written in the tag memory 205 and the write data in the data memory 206 via the processor internal bus control circuit 208, the address data path 200 and the data path for data 202.

When a data write request is made in reverse from the internal bus 6 to the data cache 20, a part of the write address is written in the tag memory 205 and the write data in the data memory 206 via the internal bus control circuit 207. In both cases, the significant bit of the entry written is set to 1, and the data cache 20 has a cache hit next time there is a request to access the entry from the internal operational unit of the processor 2.

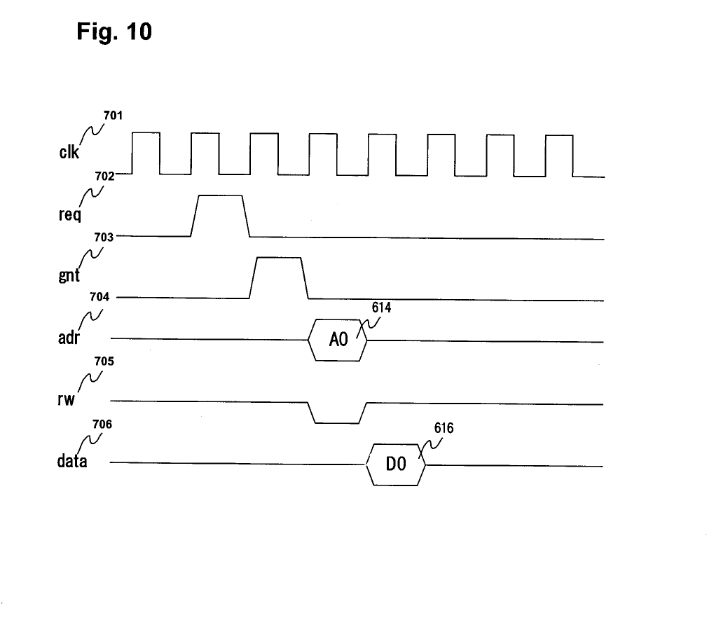

Next, we will describe how the data transfer engine with motion compensation function 1 writes operation results in the data cache 20. See FIG. 10 for an example of changes in the signals of the internal bus 6 according to the present embodiment.

To simplify the description, a bus with minimum required functions is used to describe the present embodiment, but the data transfer efficiency can be further enhanced by using such technologies as split transfer and burst transfer. Further, although the present embodiment assumes that a bus arbitration circuit 209, which performs arbitrations of the internal bus 6, is inside the internal bus control circuit 207, the bus arbitration circuit 209 can be built into other devices connected to the internal bus 6.

A reference clock 701 is supplied to all devices that are connected to the internal bus 6. A request signal 702 is a signal outputted by the data transfer engine with motion compensation function 1 and received by the bus arbitration circuit 209 within the internal bus control circuit 207. When data must be transferred to a device connected to the internal bus 6, the data transfer engine with motion compensation function 1 outputs as the request signal 702 a signal that indicates 1. The bus arbitration circuit 209 is notified of request signals from all devices connected to the bus. The bus arbitration circuit 209 determines which device to allow the use of the internal bus 6 based on the contents of the request signals received.

The bus arbitration circuit 209 notifies of a permission to use the internal bus 6 to a device permitted by setting 1 at a grant signal 703 to the device. In this example, let us assume that the bus arbitration circuit 209 has allowed the data transfer engine with motion compensation function 1 to use the internal bus 6 by setting I at the grant signal 703 to the data transfer engine with motion compensation function 1.

Once it is allowed to use the internal bus 6, the data transfer engine with motion compensation function 1 outputs an address 614 generated by the write path address generating circuit 309 in the next cycle as an address signal 704. In the present embodiment, the address signal 704 is a 32-bit wide signal, and the device to be accessed is determined by the upper 4 bits of the address signal 704.

Since the upper 4 bits of the address signal 704 correspond to a device to be accessed, the device that is to be accessed is the memory control circuit 3 if the upper 4 bits of the address signal 704 are “0000” through “0111” and the data cache 20 if the upper 4 bits are “1000,” for example. In this case, since the write path address generating circuit 309 has set the upper 4 bits of the address 614 to “1000,” the data cache 20 is designated as the data write destination.

The internal bus control circuit 301 outputs as the address signal 704 the address 614 generated by the write path address generating circuit 309, while also setting a read/write designation signal 705 to 0 to designate the current access as the write address.

In the next cycle, the internal bus control circuit 301 outputs as a data signal 706 data 616 that has been sent from the operation result output circuit 310. In the present embodiment, the data signal 706 is 64-bit wide.

In the meantime, the internal bus control circuit 207 checks the content of the upper 4 bits of the address 614 that is sent in a cycle following the cycle in which the grant signal 703 was set to 1; and since the upper 4 bits are “1000” and the read/write designation signal 705 is set to 0, it determines that the data 616 that is sent in the next cycle is data that is to be written in the data cache 20.

In the present embodiment, the data cache 20 is assumed to be a direct map cache with a capacity of 8 kB, the tag memory 205 a 20-bit wide and 1024-line memory, and the data memory 206 a 64-bit wide and 1024-line memory. The capacity of one cache line is 64 bits. The tag memory 205 stores the 31st through 13th bits and the significant bit.

When the address 614 arrives, the data path for address 200 uses the 12th through 3rd bits of the address 614 to determine a target cache line to be written in. The controller 201 uses the line number determined to read data stored in the corresponding cache line of the tag memory 205.

If the significant bit contained in the data read is 0, it indicates that there is no valid data in the cache memory that corresponds to the cache line. If this is the case, the controller 201 writes the 31st through 13th bits of the address 614 in an address storage part, and 1 in a significant bit part, of the corresponding cache line of the tag memory 205, and writes the data 616 in the corresponding line of the data memory 206. As a result, the data cache 20 has a cache hit when the processor 2 accesses the data stored in the address 614.

If the significant bit contained in the data read from the tag memory 205 is 1, it indicates that there is already valid data in the line. If this is the case, after copying the data stored in the applicable line of the data memory 206 to a register inside the data path for data 202, the controller 201 writes the 31st through 13th bits of the address 614 in the address storage part, and 1 in the significant bit part, of the corresponding line of the tag memory 205, and writes the data 616 sent in the next cycle in the corresponding line of the data memory 206. The data copied to the register inside the data path for data 202 is written in the external memory 1002 via the internal bus 6 when the internal bus 6 becomes available for use.

Although the operations are described using as an example a direct map-type data cache, the method according to the present invention can also be used with set associative-type cache. In the latter case, the line to be written in is determined using information such as an LRU control circuit inside the data cache 20, in addition to the address 614.

Next, the flow of a decompression processing of moving pictures according to the present configuration will be described.

First, the description will be made as to a processing that takes place when the data transfer engine with motion compensation function 1 is not used.

The compressed moving picture stream 1001 that has been compressed using an algorithm such as MPEG is inputted into the stream control circuit 4. The stream control circuit 4 writes in the external memory 1002 via the internal bus 6 the data of the compressed moving picture stream 1001 that was inputted. At the same time, the processor 2 reads the compressed picture data stored in the external memory 1002, performs a decompression processing, and rewrites the pictures obtained as a result of the decompression processing (hereinafter called the “original pictures”) back in the external memory 1002.

The picture output circuit 5 reads the data of the decompressed original pictures from the external memory 1002 and outputs the data to the picture display device 1003. The various processing described can be executed in parallel. Normally, the processing with the longest processing time is the processing in which the processor 2 reads the compressed data from the external memory 1002, decompresses the compressed data, and rewrites the decompressed data back in the external memory 1002. In other words, the system as a whole can be made faster by performing this processing more quickly.

Next, a description will be made as to a read decompression processing of compressed data according to the conventional technology.

In moving picture compression technique commonly used in MPEG, data columns after compression are in variable length codes. First, the processor 2 reads a compressed stream stored in the external memory 1002 and performs a decode processing of the variable length codes. By decoding the compressed stream, the motion vector and discrete cosine transformed picture data (DCT data) can be extracted. This processing is called a VLC decode processing. Although this processing is performed by the processor 2 in the present embodiment, alternatively a coprocessor dedicated to VLC decode processing may be mounted.

Thereafter, the processor 2 performs an inverse discrete cosine transform (IDCT) on the DCT data to obtain picture data before motion compensation was performed. This processing is called an IDCT processing 802. By adding reference data as necessary to the picture data before motion compensation was performed, original pictures can be obtained.

The processor 2 reads data for macro blocks of the reference frame from the external memory 1002, performs a pixel interpolation for half-pell predictions, averages a plurality of macro blocks for bidirectional predictions, and creates reference data. Hereinafter, this is called the “reference data reading plus operating” processing.

Then, the processor 2 adds the reference data obtained to the results of an IDCT processing to obtain the original pictures. This processing is called the “addition processing.” Lastly, the processor 2 writes the results in the external memory 1002. This processing is called the “storage” processing.

In the present embodiment, the “reference data reading plus operating” processing is executed by the data transfer engine with motion compensation function 1. This makes possible the execution of this processing in parallel with other processing, which shortens the overall processing time.

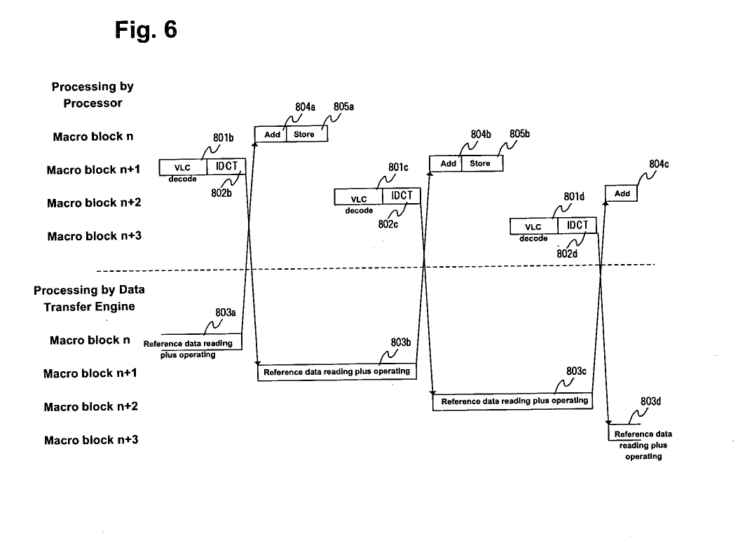

FIG. 6 is a diagram of the details of a data decompression processing when the data transfer engine with motion compensation function 1 is used.

In FIG. 6, the top half indicates processing performed by the processor 2, while the bottom half indicates processing performed by the data transfer engine with motion compensation function 1. The x-axis indicates time.

Directing our attention to a macro block n+1, first the processor 2 performs a VLC decode processing 801b and an IDCT processing 802b. Next, the processor 2 writes in a register inside the data transfer engine with motion compensation function 1 via the internal bus 6 the motion vector obtained through the VLC decode processing 801b. Next, the processor 2 issues a request to start a “reference data reading plus operating” processing 803b to the data transfer engine with motion compensation function 1. According to the present embodiment, the starting operation also takes place when the processor 2 writes data in the register inside the data transfer engine with motion compensation function 1. After completing this series of processing, the processor 2 begins a processing with regard to a macro block n.

In the meantime, the data transfer engine with motion compensation function 1 that received the start request calculates the address in the external memory 1002 where a reference macro block to be read is stored, based on a value indicating the coordinates of the macro block to be processed next and the value of the motion vector written by the processor 2, both of which are written on the register of the data transfer engine with motion compensation function 1.

Next, the data transfer engine with motion compensation function 1 uses the address calculated to read the required macro block from the external memory 1002 and writes the same in the buffer 303. If performing a bidirectional prediction is designated, the data transfer engine with motion compensation function 1 uses the other motion vector already written by the processor 2 to read the second reference macro block within the second reference frame, and writes the same in the buffer 304.

Next, the half-pell processing circuit 306 uses the content of the buffer 303, while the half-pell processing circuit 307 uses the content of the buffer 304, to perform a half-pell operation. The interpolation method is determined by the value of the motion vector used by each to write in the respective buffer.

Next, the bidirectional prediction processing circuit 308 finds an average value for each pixel of the output data from the half-pell processing circuits 306 and 307, and the average values become output data of the bidirectional prediction processing circuit 308. If no bidirectional predictions are to be performed, the averaging processing is unnecessary, and the valid one of the outputs from the half-pell processing circuits 306 and 307 becomes the output of the bidirectional prediction processing circuit 308.

The data transfer engine with motion compensation function 1 writes the output of the bidirectional prediction processing circuit 308 in the data cache 20 via the operation result output circuit 310, the internal bus control circuit 301, and the internal bus 6. The processing up to this point is called a “reference data reading plus operating” processing 803b.

After the processing 803b is completed, the processor 2 performs a processing 804b, in which the result of the IDCT processing 802b and the result of the processing 803b are added on a pixel-by-pixel basis. Since both results are stored in the data cache 20 by this time, this processing can be performed at high-speed without causing any cache error.

Lastly, the processor 2 writes the result of the processing 804b in the external memory 1002 through a storage processing 805b.

In this way, due to the fact that it is the data transfer engine with motion compensation function 1 and not the processor 2 that performs the “reference data reading plus operating” processing 803b, the processor 2 is free to execute other processing while the processing 803b is being executed. According to the present embodiment, while the data transfer engine with motion compensation function 1 is executing the processing 803b, the processor 2 executes an addition processing 804a and a storage processing 805a of the macro block n, which is the macro block immediately preceding the macro block to be decompressed, as well as a VLC decode processing 801c and an IDCT processing 802c of the macro block n+2, which is the macro block immediately following the macro block to be decompressed.

By pipelining the decompression processing of compressed data, the processing capability of the system as a whole can be improved without wasting the processing capability of the processor 2.

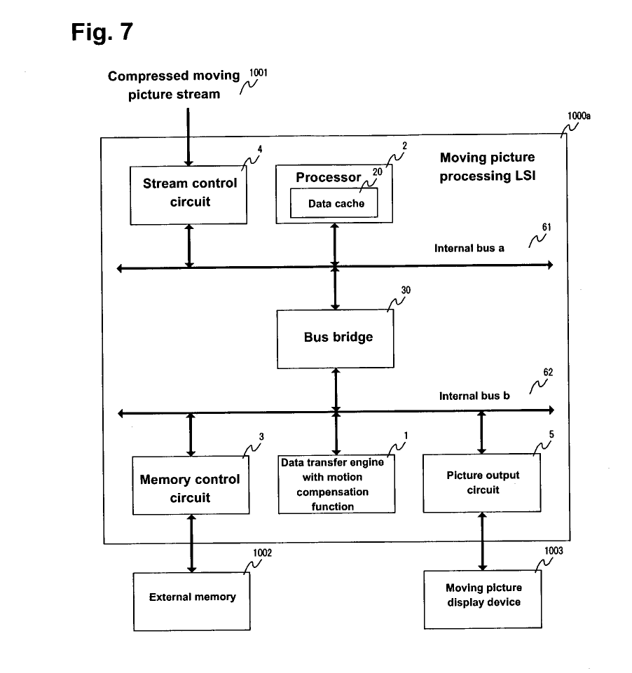

FIG. 7 is a diagram of the configuration of a processor system in accordance with a second embodiment of the present invention. It differs from the first embodiment in that a moving picture processing LSI 1000a has a plurality of internal buses 61 and 62, and that the internal buses 61 and 62 are connected by a bus bridge 30. Although the internal bus 6 is divided in two in this example, the internal bus may be three or more in number.

By dividing the bus in this way, the number of devices connected to each bus can be reduced. Further by dividing the bus in this way, the physical wire length of the buses can be shortened, which would be advantageous from high-speed operating frequency and energy saving perspectives.

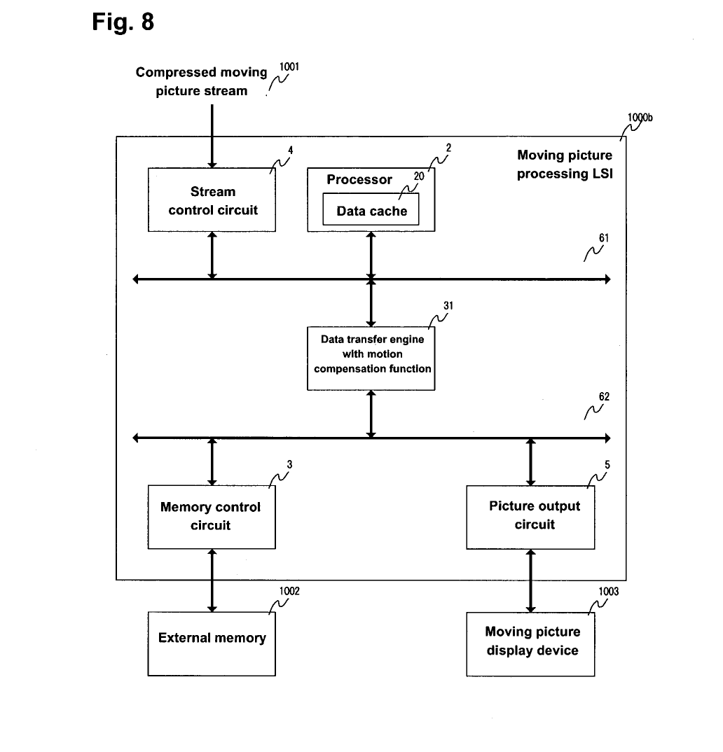

FIG. 8 is a diagram of the structure of a processor system in accordance with a third embodiment of the present invention as a further development of FIG. 7. The third embodiment differs from the first and second embodiments in that a bus bridge and a data transfer engine with motion compensation function are formed by a single device. Consequently, in the present embodiment, effects such as improved operating frequency can be obtained from having the bus divided, as in the second embodiment. Furthermore, according to the present embodiment, due to the fact that a data transfer engine with motion compensation function 31 is connected to two internal buses, the data transfer engine with motion compensation function 31 can access each bus independently.

In other words, at the same time reference data is read into the data transfer engine with motion compensation function 31 from an external memory 1002 via an internal bus 62, the results of motion compensation can be written in a data cache 20 via an internal bus 61. As a result, the data transfer load on each internal bus can be distributed, which makes it possible to improve the data transfer performance of the system as a whole.

The data transfer engine with motion compensation function 31 used in the present embodiment differs from the data transfer engine with motion compensation function 1 used in the first embodiment in that a plurality of internal buses 61 and 62 is connected to an internal bus control circuit 301.

As a fourth embodiment of the present invention, a processor system may have a configuration in which a data transfer engine with scaling function 60, instead of the data transfer engine with motion compensation function 1, is mounted on a moving picture processing LSI 1000.

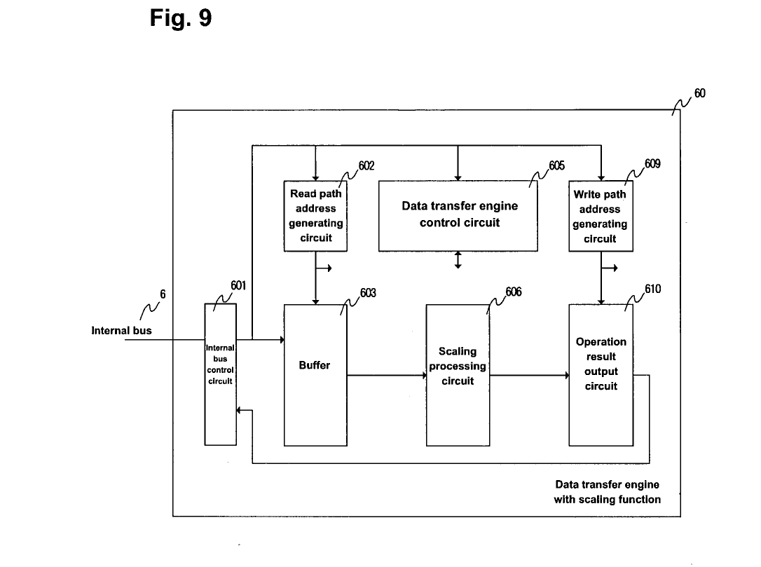

FIG. 9 is a diagram of the internal configuration of the data transfer engine with scaling function 60. The data transfer engine with scaling function 60 is provided with an internal bus control circuit 601, a read path address generating circuit 602, a buffer 603, a data transfer engine control circuit 605, a scaling processing circuit 606, a write path address generating circuit 609, and an operation result output circuit 610.

The scaling processing circuit 606 is a circuit that performs a two-dimensional filtering processing on pixels that are within a specified range of a display region. By using this circuit, the moving picture processing LSI 1000 can enlarge and reduce pictures. Further, by manipulating the coefficient of the two-dimensional filter, processing such as contour enhancement can be performed. Using the data transfer engine with scaling function 60, pictures stored in an external memory 1002 can be reduced before being transferred to a data cache 20. This can reduce the amount of operations required of a processor 2 if the resolution of the picture ultimately required is low.

Moreover, when performing a compression processing of moving pictures, the performance of the system can be enhanced by using a data transfer engine with motion prediction function 50 instead of the data transfer engine with motion compensation function 1. The data transfer engine with motion prediction function 50 finds from a reference frame a macro block that is most similar to a macro block that is to be compressed and calculates its relative coordinates, i.e., its motion vector. The data transfer engine with motion prediction function 50 then transfers the motion vector to a data cache 20.

In the above embodiments, systems in which one coprocessor is mounted have been described. However, due to the fact that a coprocessor and a data cache are connected via a bus according to the present invention, the coprocessor or the data cache may be plural in number. If the number of coprocessor is increased, data can be written from any of the coprocessors in the data cache.

Conversely, if the number of data cache is increased, a coprocessor can write data in one data cache selected or in a plurality of data caches.

Due to the fact that the data cache is connected to the bus according to the present invention, another advantage is that there is virtually no need to make any changes to the data cache even if the number of coprocessors connected to the bus is increased.

Although the data cache was used as an example in the above description, the present invention is not limited to applications to the data cache. When a conversion circuit is used for instructions executed by a processor acting as a coprocessor, its operation results are written on the instruction cache.

According to the present invention, the operation results of a coprocessor can be sent at high-speed to a processor, while taking advantage of the ease of programming of the data cache method. This makes it possible to improve the performance of the system as a whole. In addition, even when the number of coprocessor is increased, the increase in the area of the data cache can be minimized.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A system comprising:
a first processor having a first memory;
a second processor for performing a specified processing; and
a bus that connects the first processor and the second processor,
wherein the second processor includes a module that generates an address for accessing a device that is connected to the bus, and
the second processor transfers an operation result obtained by the second processor to the first memory based on the address generated by the module.

2. A system according to claim 1, wherein the second processor accesses the first memory via the bus.

3. A system according to claim 1, wherein the first processor and the second processor operate on different instruction systems.

4. A system according to claim 1, wherein the operation result of the second processor is written in the first memory regardless of data values stored in a tag memory that composes the first memory.

5. A system according to claim 1, wherein the second processor performs a motion compensation processing.

6. A system according to claim 5, further comprising a second memory that stores a result of the motion compensation processing performed by the first processor and the second processor, wherein the second processor transfers an interim result of the motion compensation processing to the first processor without storing the interim result in the second memory, and the first processor generates a final result of the motion compensation processing using the interim result, and stores the final result in the second memory.

7. A system according to claim 1, wherein the first processor and the second processor are connected to different buses that are connected by a bus bridge, the second processor generates addresses for accessing devices that are connected to the different buses, and the second processor writes operation results via the bus bridge in the first memory via the buses.

8. A system according to claim 7, wherein the second processor is connected to both of the different buses.

9. A system according to claim 7, wherein the second processor performs a scaling processing on a picture.

10. A system according to claim 7, wherein the second processor detects motion vectors.

11. A coprocessor for a processor having a first memory, the coprocessor comprising an address generation module that is required to write a result of an operation via a bus connected to the processor.

12. A coprocessor according to claim 11, wherein the processor and the coprocessor have different instruction systems.

13. A coprocessor according to claim 12, wherein the operation is a motion compensation processing.

14. A system according to claim 1, wherein the first memory is a data cache.

15. A coprocessor according to claim 13, wherein the first memory is a data cache.

16. A processing method for a system comprising a first processor having a first memory, a second processor for performing a specified processing, and a bus that connects the first processor and the second processor, the processing method comprising the steps of:
making a module included in the second processor generate an address for accessing a device that is connected to the bus; and
making the second processor transfer an operation result obtained by the second processor to the first memory based on the address generated.

17. A processing method according to claim 16, wherein the second processor accesses the first memory via the bus.

18. A processing method according to claim 16, wherein the first processor and the second processor operate on different instruction systems.

19. A processing method according to claim 16, wherein the operation result of the second processor is written in the first memory regardless of data values stored in a tag memory that composes the first memory.

20. A processing method according to claim 16, wherein the second processor performs a motion compensation processing.

21. A processing method according to claim 20, further comprising the steps of:
making a second memory store a result of the motion compensation processing performed by the first processor and the second processor;
making the second processor transfer an interim result of the motion compensation processing to the first processor without storing the interim result in the second memory;
making the first processor generate a final result of the motion compensation processing using the interim result; and
storing the final result in the second memory.

22. A processing method according to claim 16, wherein the first memory is a data cache.

23. A processing method according to claim 21, wherein the first memory is a data cache.
